(19) United States
(12) Patent Application Publication
(10) Pub. No.: US 2026/0169891 A1
(43) Pub. Date: Jun. 18, 2026

(54) PROBING SUITE FOR CODE EMBEDDINGS

(71) Applicant: SAP SE, Walldorf (DE)

(72) Inventors: Rocio Cabrera Lozoya, Antibes (FR); Antonino Sabetta, Mouans Sartoux (FR)

(21) Appl. No.: 18/984,343

(22) Filed: Dec. 17, 2024

(51) Int. Cl. G06F 11/3604

(52) U.S. Cl. CPC G06F 11/3604

(57) ABSTRACT

The disclosure generally describes methods, software, and systems for identification of code embeddings. A source code fragment is received. Embedding models corresponding to the source code fragment are determined. Each of the embedding models converts the source code fragment into numerical vectors that capture a semantic meaning and a functionality of the source code fragment. Probes corresponding to properties of the source code fragment are determined. Each of the probes perform an analysis of the properties of the source code fragment. Performance metrics indicative of encapsulations of the probes in the embedding models are generated, using a machine learning model trained to process the embedding models and the probes. A ranked representation of the embedding models is generated using the performance metrics.

### TECHNICAL FIELD

The present disclosure relates to software code analysis. More particularly, implementations of the present disclosure are directed to a probing suite to identify code embeddings.

### BACKGROUND

Embeddings have been used to convert software artifacts (e.g., code, bytecode) into vectors that can be readily provided as an input to machine learning models. The amplified focus on machine learning models motivated an increased usage of embedding models for software artifacts. Currently, a vast array of embedding models is available. Some of the available embedding models have good performances in concrete code-related tasks, such as vulnerability detection, code clone detection, and documentation generation. Embedding models applied to complex software artifacts often present lower performances. Such embedding models are more difficult to analyze, to determine what type of information is captured by the learned representations. The selection of a particular embedding model from the vast array of embedding models can be challenging, the difficulty increasing with the complexity of the software artifacts.

### SUMMARY

Implementations of the present disclosure are directed to software code analysis. More particularly, implementations of the present disclosure are directed to a probing suite to identify code embeddings.

In some implementations, a method includes: receiving a source code fragment, determining embedding models corresponding to the source code fragment, each of the embedding models converting the source code fragment into numerical vectors that capture a semantic meaning and a functionality of the source code fragment, determining probes corresponding to properties of the source code fragment, each of the probes performing an analysis of the properties of the source code fragment, generating, using a machine learning model trained to process the embedding models and the probes, performance metrics indicative of encapsulations of the probes in the embedding models, and generating, a ranked representation of the embedding models using the performance metrics.

The foregoing and other implementations can each optionally include one or more of the following features, alone or in combination. In particular, implementations can include all of the following features:

In some aspects, combinable with any of the previous aspects, wherein the machine learning model includes a support vector machine, a random forest, or a fully convolutional network. The machine learning model is trained using labeled probes and labeled embedding models to determine whether one of the labeled probes is encapsulated in the labeled embedding models. The computer-implemented method including selecting one of the embedding models using the performance metrics to convert the source code fragment into the numerical vectors. The embedding models include any of a graph-based model, a large language model, a token-based model, an abstract syntax tree model, and a transformer-based model. The probes include any of a parser and a code dependency graph analyzer. The properties of the source code fragment are aligned with downstream tasks targeted by the embedding models.

Other implementations of the aspect include corresponding systems, apparatus, and computer programs, configured to perform the actions of the methods, encoded on computer storage devices.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

These and other implementations can each optionally include one or more of the following advantages. The described implementation provides an efficient probing suite to accurately identify and isolate individual code characteristics that are contained in embeddings generated from different embedding models. The identified embedding models can be applied to complex software artifacts with increased analysis performances. The described probing suite advantageously facilitates efficient evaluation of different embedding models against a set of relevant and interpretable tasks to automatically select the most relevant embedding model for a respective source code artifact. The described probing suite also advantageously facilitates embedding model providers to benchmark developed models according to particular tasks. As a result, an optimized selection of embedding models based on corresponding probes can enhance the accuracy and consistency of the identification of individual code characteristics facilitating trained machine learning models to correctly evaluate code-related tasks.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the subject matter of the specification are set forth in the accompanying drawings and the description below. Other features, aspects, and advantages of the subject matter will become apparent from the description, the drawings, and the claims.

### DESCRIPTION OF DRAWINGS

FIG. 1 is a block diagram of an example system for identification of code embeddings using a probing suite, according to some implementations of the present disclosure.

FIG. 2 is a block diagram of an example system architecture for identification of code embeddings using a probing suite, according to some implementations of the present disclosure.

FIG. 3 is a flowchart of an example process for identification of code embeddings using a probing suite, according to some implementations of the present disclosure.

FIG. 4 is a block diagram of an exemplary computer system used to provide computational functionalities associated with described algorithms, methods, functions, processes, flows, and procedures, according to some implementations of the present disclosure.

Like reference numbers and designations in the various drawings indicate like elements.

### DETAILED DESCRIPTION

The present disclosure relates to software code analysis. More particularly, implementations of the present disclosure are directed to a probing suite to identify and isolate individual code characteristics that are contained in embeddings generated by different embedding models. The probing suite facilitates direct evaluation of different embedding models against a set of relevant and easily interpretable tasks defined by corresponding probes, to choose the most relevant embedding models for a particular software artifact. A software artifact can include a source code fragment (e.g., code, bytecode) that is targeted for analysis. Embedding models corresponding to the source code fragment are determined as potential matches for the software artifact. Each of the identified embedding models converts the source code fragment into vectors (sentence representations) that capture a semantic meaning and a functionality of the source code fragment. Probes that correspond to properties of the source code fragment are determined. Each probe performs an analysis of the properties of the source code fragment. A probing suite generates performance metrics indicative of encapsulations of the probes in the embedding models, reflecting which properties of the input software artifact are retained by the embeddings. The performance metrics are used to rank the embedding models to identify a matching embedding model for processing the software artifact. The matching embedding model processes the software artifact to convert the respective software artifacts into vectors that can be provided as an input to machine learning models trained to analyze code-related tasks.

Some traditional embedding model selections are limited to model exposure through a service application programming interface (API). Many software libraries are associated with a wide range of embedding models to choose from. Testing each of the embedding models in the full pipeline of the use case can be expensive, while a random selection can lead to inaccurate vectorization. Avoiding testing of all embedding models and the random selection, a set of embedding models can be selected and evaluated relative to all the available probes of a probing suite. The evaluation using all available probing suites provides measures that identify single and interpretable code characteristics represented in the respective embeddings. The identification of single and interpretable code characteristics facilitate a selection of an embedding model to target the downstream applications, for which a respective embedding model can be better suited. A limitation of the described traditional approach for embedding model selections is that it generally selects from a limited, unoptimized set of models. As a limiting result, machine-learning models processing vectors generated by randomly selected embedding models provide results constrained by the limited individual code characteristics, potentially missing a critical analysis of excluded code-related tasks.

Addressing the limitations of traditional embedding model selection protocols, the described approach includes a probing suite that executes an embedding model selection process. The described probing suite assesses the capabilities of embedding models using a set of probing tasks defined by corresponding probes. The probes address a single question, minimizing interpretability problems and provide selective constraints on the evaluation of different embedding models against a set of relevant and quantitatively interpretable tasks to accurately select the most relevant embedding model for the respective source code. The described probing suite imposes identification and isolation of individual code characteristics that are contained in embeddings generated from different embedding models. The selection of a matching embedding model facilitates vectorization of relevant features of the source code to provide as an input to machine learning models trained to perform an optimized analysis of risks and vulnerabilities of software systems. The described selection of a matching embedding model leads to an increase in accuracy of embedding model applicability to a particular source code, being practically applicable to systems designed as embedding model consumers or embedding model providers.

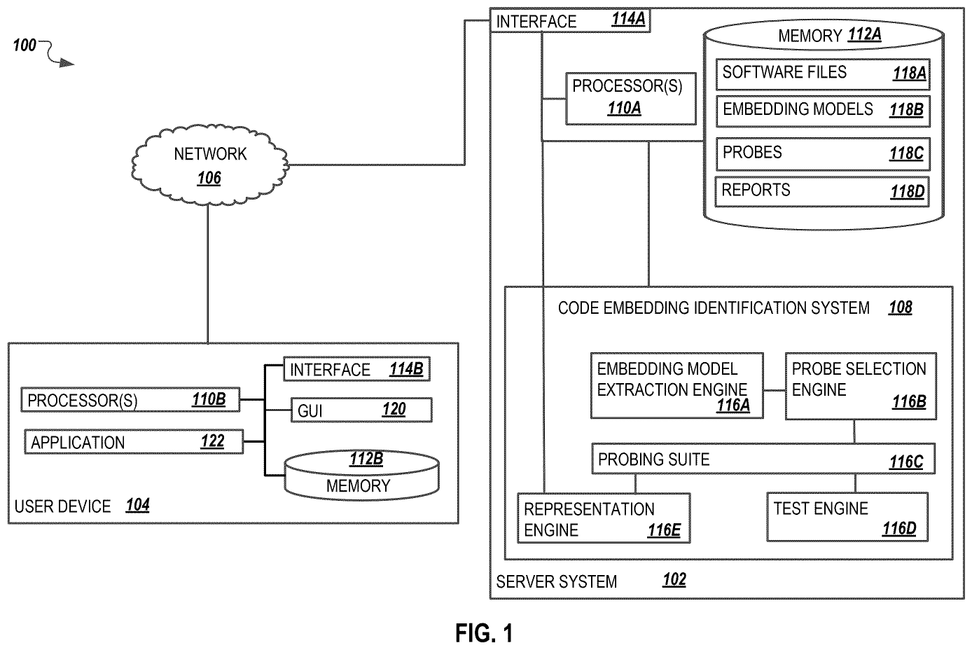

FIG. 1 is a block diagram of an example system 100 for identification of code embeddings using a probing suite, according to some implementations of the present disclosure. Specifically, the illustrated example system 100 includes or is communicably coupled with a server system 102, an user device 104, and a network 106. Although shown separately, in some implementations, functionality of two or more systems or servers can be provided by a single system or server. In some implementations, the functionality of one illustrated system, server, or component can be provided by multiple systems, servers, or components, respectively.

In the example of FIG. 1, the server system 102 is intended to represent various forms of servers including, but not limited to a web server, an application server, a proxy server, a network server, and/or a server pool. In general, server systems 102 accept requests for application services including probing services and provides such services to any number of user devices 104 (e.g., the user device 104 over the network 106). In accordance with implementations of the present disclosure, and as noted above, the server system 102 can host a solution environment that can be a cloud environment providing software applications, systems, and services that can be consumed by customers as a service. In some instances, the server system 102 can support configuring of various tenants of different types, as well as services of different types that are integrated in customer integration scenarios and support execution of defined processes associated with identification and isolation of individual code characteristics that are contained in embeddings generated by different embedding models. For example, the server system 102 includes a code embedding identification system 108, a processor 110A, a memory 112A, and an interface 114A.

The code embedding identification system 108 can include an embedding model extraction engine 116A, a probe selection engine 116B, a probing suite 116C, a test engine 116D, and a representation engine 116E. The code embedding identification system 108 is coupled to the processor 110A, the memory 112A, and the interface 114A for identification of code embeddings using the probing suite 116C using data stored in the memory 112A. The memory 112A can include source code files 118A, embedding models 118B, probes 118C, and reports 118D.

For example, as user devices 104 generate requests for identification of a code embedding model for analyzing source code files 118A. The source code files 118A can be processed by the embedding model extraction engine 116A to extract a source code fragment. The embedding model extraction engine 116A can process the source code fragment to determine candidate embedding models 118B corresponding to the source code fragment. The embedding models used by the embedding model extraction engine 116A can include a prediction model, such as a random forest model, a support vector machine, or a fully connected network. The random forest model can include an ensemble learning method that constructs multiple decision trees during training and outputs the performance metrics by matching the selected embedding models 118B with the selected probes 118C as classes (classification) or as mean prediction (regression) of the individual trees. The probe selection engine 116B can process the source code fragment to determine probes 118C corresponding to the source code fragment.

The probing suite 116C can call the test engine 116D to generate performance metrics indicative of encapsulations of the selected probes 118C in the selected embedding models 118B. The test engine 116D can use a trained machine learning model to generate performance metrics by matching the selected embedding models 118B with the selected probes 118C. The probing suite 116C can rank the candidate embedding models 118B according to the performance metrics to select embedding models 118B relevant for the source code fragment. The probing suite 116C can transmit the ranked embedding models 118B to the representation engine to generate reports 118D transmitted to the user device 104, to be displayed on the GUI 120 and stored in the memory 112A.

The components of the code embedding identification system 108, including the probing suite 116C and the test engine 116D can include machine learning functionality for optimizing identification of a code embedding model for analyzing source code files 118A. For example, the test engine 116D can use a prediction model to process the prompt and analyze the code fragments to identify code vulnerabilities. The support vector machine can include a supervised learning model that is used for classification of the selected embedding models 118B with the selected probes 118C. The support vector machine can generate the performance metrics by finding the hyperplane that best separates the data into different classes.

The fully connected network model can include a type of artificial neural network where each neuron in one layer is connected to every neuron in the next layer. The fully connected network model can match the selected embedding models 118B with the selected probes 118C to generate the performance metrics. The test engine 116D can be further optimized by efficient training of the adjusted weights of the prediction model using labeled negative and positive probe to embedding model matches. The test engine 116D can optimize machine learning training using ranked positive matches that effectively increase an accuracy of the performance metrics.

In general, the user device 104 includes an electronic computer device operable to receive, transmit, process, and store any appropriate data associated with the system 100 of FIG. 1. The user device 104 can encompass any client computing device such as a laptop/notebook computer, wireless data port, smart phone, personal data assistant (PDA), tablet computing device, one or more processors within these devices, or any other suitable processing device. The user device 104 includes an interface 114B, a processor 110B, a memory 112B, and a graphical user interface (GUIs) 120. The user device 104 can include one or more applications 122. The application 122 can be any type of application that allows a user device to request and view content on the user device (e.g., generate a request for a probing suite to identify and isolate individual code characteristics that are contained in embeddings generated by different embedding models). In some implementations, an application 122 can use parameters, metadata, and other data to access the code embedding identification system 108 from the server system 102. In some instances, an application 122 can be an agent or client-side version of the one or more enterprise applications running on an enterprise server (not shown).

In accordance with implementations of the present disclosure, the application 122 includes a digital assistant that enables interactions with the user device 104. For example, and as described in further detail herein, the digital assistant of the user device 104 can receive a query. In some examples, one or more query responses can include data that is presented as a graphical representation in the GUI 120. In accordance with implementations of the present disclosure, the digital assistant can present data as a graphical representation in a popover container within a window therein. In some examples, the popover container is provided as an iframe-based container and the digital assistant communicates with the popover container using remote procedure calls.

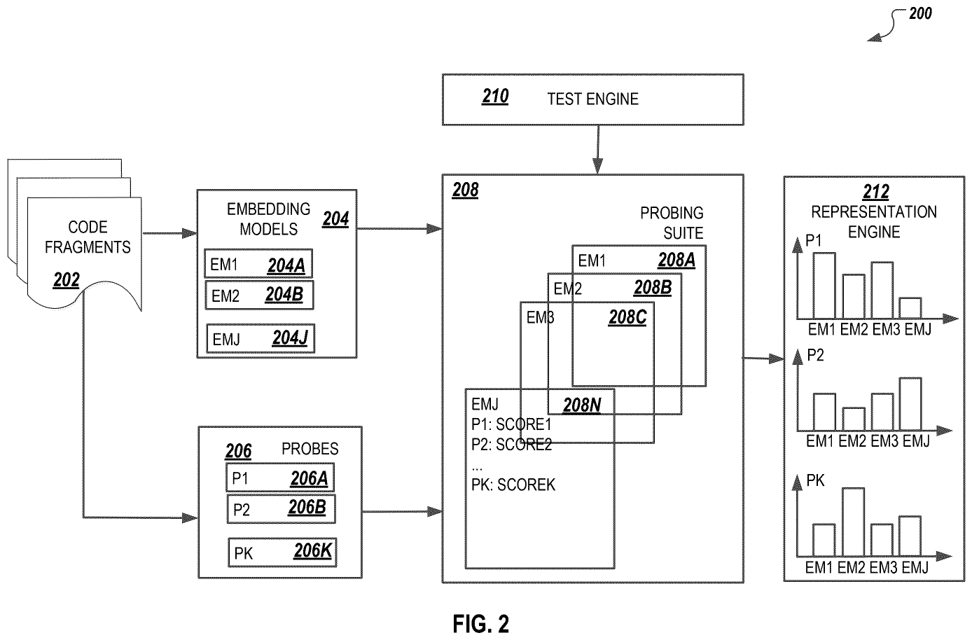

As described in further detail herein, a user can input a query to the digital assistant and the digital assistant can receive a response to the query. In accordance with implementations of the present disclosure, the response can include a display of reports 118D, as described with reference to FIG. 2. In some examples, the graphical representation can be provided as a web-based rendering using a web rendering runtime that is built into the popover container (e.g., iframe). In some examples, the graphical representation is compatible with a UI framework of the popover container. An example UI framework includes, without limitation, SAPUI5 provided by SAP SE of Walldorf, Germany.

In some implementations, any or all of the components of the example system 100, both hardware or software (or a combination of hardware and software), may interface with each other or the interface(s) 114A, 114B (or a combination of both) over the network 106 for identification and isolation of individual code characteristics that are contained in embeddings generated by different embedding models. The functionality of the user device 104 can be accessible for all service consumers using the application 122 that transmits prompts to the code embedding identification system 108 to generate reports 118D.

For example, the user device 104 may include a computer that includes an input device, such as a keypad, touch screen, or other device that can accept user information, and an output device that conveys information associated with the operation of the server system 102, or the user device itself, including digital data, visual information, or a GUI 120, respectively. The GUI 120 each interface with at least a portion of the system 100 for any suitable purpose, including generating a visual representation of the application 122 or the software files 118A, respectively. In particular, the GUI 120 can be used to view and navigate various Web pages. The GUI 120 can provide the user with an efficient and user-friendly presentation of data provided by or communicated within the system. The GUI 120 can include a plurality of customizable frames or views having interactive fields, pull-down lists, and buttons operated by the user. The GUI 120 can include any suitable graphical user interface, such as a combination of a generic web browser, intelligent engine, and command line interface (CLI) that processes information and efficiently presents the results to the user visually.

In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems. Data exchanged over the network 106, is transferred using any number of network layer protocols, such as Internet Protocol (IP), Multiprotocol Label Switching (MPLS), Asynchronous Transfer Mode (ATM), Frame Relay, etc. Furthermore, in implementations where the network 106 represents a combination of multiple sub-networks, different network layer protocols are used at each of the underlying sub-networks. In some implementations, the network 106 represents one or more interconnected internetworks, such as the public Internet.

Each processor 110A, 110B included in the user device 104 can be a central processing unit (CPU), an application specific integrated circuit (ASIC), a field-programmable gate array (FPGA), or another suitable component. Each processor 110A, 110B included in the user device 104 executes instructions and manipulates data to perform the operations of the user device 104, respectively. Specifically, each processor 110A, 110B included in the user device 104 executes the functionality required to send requests to the server system 102 and to receive and process responses from the server system 102. Each processor 110A, 110B can be a CPU, a blade, an ASIC, a FPGA, or another suitable component. Each processor 110A, 110B executes instructions and manipulates data to perform the operations of the respective system (the server system 102, the user device 104). Specifically, each processor 110A, 110B executes the functionality required to receive and respond to requests from the respective system (the server system 102, the user device 104), for example.

Interfaces 114A, 114B are used by the server system 102, the user device 104, respectively, for communicating with other systems in a distributed environment—including within the system 100—connected to the network 106. Generally, the interfaces 114A, 114B each include logic encoded in software and/or hardware in a suitable combination and operable to communicate with the network 106. More specifically, the interfaces 114A, 114B may each include software supporting one or more communication protocols associated with communications such that the network 106 or interface's hardware is operable to communicate physical signals within and outside of the illustrated system 100.

The memory 112A, 112B may include any type of memory or database module and may take the form of volatile and/or non-volatile memory including, without limitation, magnetic media, optical media, random access memory (RAM), read-only memory (ROM), removable media, or any other suitable local or remote memory component. The memory 112A, 112B may store various objects or data, including caches, classes, frameworks, applications, backup data, business objects, jobs, web pages, web page templates, database tables, database queries, repositories storing business and/or dynamic information, and any other appropriate information including any parameters, variables, algorithms, instructions, rules, constraints, or references thereto associated with the purposes of the server system 102, or the user device 104, respectively.

There can be any number of user devices 104 and API provider systems 110 associated with, or external to, the system 100. Additionally, the example system 100 can include one or more additional user devices external to the illustrated portion of system 100 that are capable of interacting with the system 100 via the network(s) 106. Further, the term “client,” “user device,” and “user” can be used interchangeably as appropriate without departing from the scope of the disclosure. Moreover, while user device can be described in terms of being used by a single user, the disclosure contemplates that many users may use one computer, or that one user may use multiple computers. As used in the present disclosure, the term “computer” is intended to encompass any suitable processing device. For example, although FIG. 1 illustrates a single server system 102, a single user device 104, the system 100 can be implemented using a single, standalone computing device, two or more servers 102, or multiple user devices. The server system 102, and the user device 104 may include any computer or processing device such as, for example, a blade server, general-purpose personal computer (PC), Mac®, workstation, UNIX-based workstation, or any other suitable device. In other words, the present disclosure contemplates computers other than general purpose computers, as well as computers without conventional operating systems. Further, the server system 102 and the user device 104 can be adapted to execute any operating system or runtime environment, including Linux, UNIX, Windows, Mac OS®, Java™, Android™, iOS, BSD (Berkeley Software Distribution) or any other suitable operating system. According to one implementation, the server system 102 may also include or be communicably coupled with an e-mail server, a Web server, a caching server, a streaming data server, and/or another suitable server.

Regardless of the particular implementation, “software” may include computer-readable instructions, firmware, wired and/or programmed hardware, or any combination thereof on a tangible medium (transitory or non-transitory, as appropriate) operable when executed to perform at least the processes and operations described herein. Indeed, each software component can be fully or partially written or described in any appropriate computer language including C, C++, Java™, JavaScript®, Visual Basic, assembler, Perl®, ABAP (Advanced Business Application Programming), ABAP OO (Object Oriented), any suitable version of 4GL, as well as others. While portions of the software illustrated in FIG. 1 are shown as individual modules that implement the various features and functionality through various objects, methods, or other processes, the software may instead include multiple sub-modules, third-party services, components, libraries, and such, as appropriate. Conversely, the features and functionality of various components can be combined into single components as appropriate. The communication between the end user device 104 and the server system 102 can include several different communication protocols configured to optimize identification of code embeddings using a probing suite, as further described in detail with reference to FIGS. 2-4.

FIG. 2 is a block diagram of an example system architecture 200 for identification of code embeddings using a probing suite, according to some implementations of the present disclosure. The example system architecture 200 includes source code fragments 202 (e.g., memory 112A described with reference to FIG. 1), embedding models 204, probes 206, a probing suite 208, a test engine 210, and a representation engine 212.

The source code fragments 202 can include a portion of a source code files. The source code fragments 202 can be mined from varied sources (e.g., source code files of projects on different applications, coding languages). The source code files can be files with a predetermined set of file extensions (e.g., “.java,” “.cpp,” “.py,” “.js,” “.cs,” “.rb,” “.php,” “.html,” “.css,” “.ts,” “.swift,” “.kt,” “.go,” “.rs,” “.m,” “.sh,” and “.pl”), that are indicative of code changes. The source code files can include changed source code files of software systems or new source code files generated for the software systems. The changed source code files refer to source code files, previously stored in a memory (e.g., memory 112A described in detail with reference to FIG. 1). The source code fragments 202 can include the modifications of the changed source code files, such as additions and deletions of code segments. The source code fragments 202 can include the modifications that can range from minor changes to substantial changes, reflecting updates, bug fixes, or enhancements to the software systems. The source code fragments 202 can include new source code files that are entirely new additions to the software systems, being stored in the memory, representing new features or components being integrated into the existing codebase. The source code fragments 202 can be extracted from different datasets having different code granularities (e.g., code snippets, methods, files, or complete projects). The source code fragments 202 can form labeled sets (e.g., a training set or a test set) or an unlabeled set. The source code fragments 202 can be processed to identify embedding models 204 and probes 206.

The embedding models 204 can include algorithms or models that can process as input the source code fragments 202 and can generate as output a textual (e.g., numerical) representation of the source code fragments 202. For example, The embedding models 204 can include machine learning models trained to transform high-dimensional data into lower-dimensional vectors while preserving essential information of the source code fragments 202. The nature of the embedding model 204 can vary depending on the type of embedding. For example, embedding models 204 can include word-based models, graph-based models, large language models, among others. The embedding models 204 that include large language models can be bidirectional encoder representations from transformers, generative pre-trained transformer, or knowledge-enhanced pre-trained models.

The probes 206 can include specific tests or measurements designed to evaluate isolated properties of source code fragments 202. Examples of probes 206 include syntax probes, semantic probes, structural probes, and performance probes. The syntax probes can be parser-based probes that use a parser to check for syntactic correctness, identify specific language constructs, or measure code complexity. For example, a probe might count the number of nested loops or conditional statements in a code fragment. Semantic probes can verify that variables and expressions conform to expected types, by ensuring that type safety and consistency are satisfied across the code. As another example, semantic probes can be data flow analysis probes that analyze the flow of data through the code to detect potential issues like uninitialized variables or dead code, using tools that construct and analyze data flow graphs. Structural probes can be code dependency graph probes that examine the dependencies between different parts of the code. Structural probes can analyze call graphs to understand function dependencies or module interaction. As another example, structural probes can be flow-graph probes that evaluate the control flow within the code to identify unreachable code or potential infinite loops. Performance probes can be profiling probes that measure the performance characteristics of the code, such as execution time, memory usage, or CPU utilization. Performance probes can provide detailed insights into which parts of the code are most resource intensive. The probes 206 correspond to isolated code properties of the source code fragments 202 that can be analytically determined through an oracle. The oracle can include a specialized tool like a parser or analyzer a code dependency graph. The parser can be a tool that analyzes the syntactic structure of the source code fragment. The analyzer can be a static analyzer that perform various checks on the source code fragment without executing the source code fragment. The analyzer can be a graph analysis tool that can visualize and analyze code dependency graphs.

The probing suite 208 can process the embedding models 204 and probes 206, to obtain a ranked list of embedding models 204 applicable to a respective source code fragment 202. The probing suite 208 can obtain the ranked list of embedding models 204 applicable to the respective source code fragment 202 by using a trained machine learning mode, provided by the test engine 210. The test engine 210 can include a machine learning model (e.g., support vector machine, a random forest model, or a fully connected network) that can be trained on the code embeddings and probe values to determine if a code characteristic (probe) is encapsulated in the embedding.

For each probe probing task, the probing suite 208 trains a machine learning model (provided by the test engine 210) using embeddings obtained from a training set of the source code fragments, by a respective embedding model 204 as inputs and the probe values obtained by applying the oracle on the code fragments as labels. If j embedding models 204A-204J and k probes 206A-206K are used, probing suite 208 can train jxk machine learning models 208A-208N. The probing suite 208 can use the trained machine learning models 208A-208N to generate performance metrics for ranking embedding models 204A-204J based on relevance to a respective source code fragment 202. The embedding models 204A, 204B with highest performance metrics are the embedding models 204A, 204B identified as best working for the source code fragments 202. In some implementations, embedding models 204B-204J with performance metrics below a set threshold can be removed from reports.

The representation engine 212 can receive reports received from the probing suite 208 and process them for display. The representation engine 212 can iteratively process each performance metric included in the report and display each embedding model-probe pair in a user-friendly dashboard for visualization. The reported results include the test subset of the source code fragments 202.

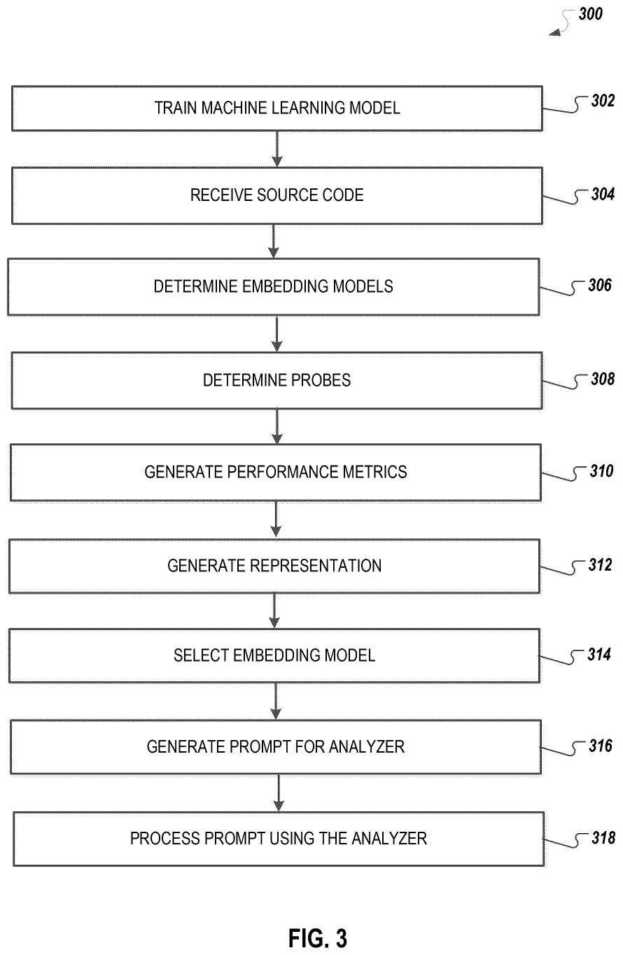

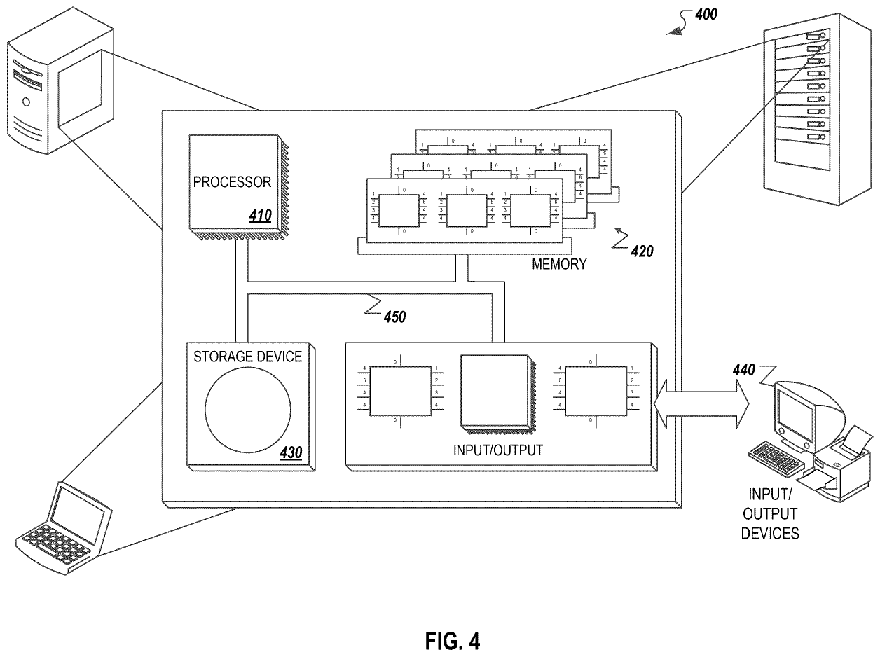

FIG. 3 is a flowchart of an example process 300 for identification of code embeddings using a probing suite, according to some implementations of the present disclosure. The example process 300 can be performed by any component of the example system 100, described with reference to FIG. 1 or the example system architecture 200, described with reference to FIG. 2 or the example computing system 400, described with reference to FIG. 4. For clarity of presentation, the description that follows describes the example process 300 in the context of the systems described with reference to FIGS. 1, 2, and 4.

At 302, a machine learning model is trained to identify embedding models most relevant for a source code fragment using labeled probes. The labeled probes can be designed to perform probing tasks, to train the machine learning model to identify relevant embedding models and test the identification of relevant embedding models for isolated code properties. The isolated code properties can be aligned with the downstream tasks, for which the embedding models are intended to be used. The probes can include surface probes and specialized probes. The surface probes can be defined as probes that are independent from specialized tools, such as an oracle. For example, surface probes can determine a size of a code fragment, invocation of a list of sensitive calls, and presence of comments. The oracle of surface probes can include a text editor, or a regular expression matching function configured to complete the task. The specialized probes require a specialized oracle, in the form of a parser, a static code analyzer or other specialized oracle. The specialized probes refer to syntactical and semantical properties of source code (e.g., cyclomatic complexity, N-path complexity, coupling, programming language, facts extracted from call graphs, data dependency graphs, control-flow graphs and other. The machine learning model can include a support vector machine, a random forest, or a fully convolutional network. The machine learning model can be trained using labeled probes and labeled embedding models to determine whether one of the labeled probes is encapsulated in the labeled embedding models. The labeled pairs of probes and embedding models can be stored as reference classification models.

At 304, a source code fragment is received, by the one or more processors. The source code fragment can be directly received, or an identifier of the source code fragment can be received, to trigger a retrieval of the source code fragment, from one or more files in a dataset. For example, an identifier of a source code fragment to be analyzed according to a particular analysis scope (e.g., identification of data flow issues) can be received.

At 306, embedding models designed to perform a portion of the particular analysis scope on the source code fragment are determined, by the one or more processors. The embedding models can include any of a graph-based model, a large language model, a token-based model, an abstract syntax tree model, and a transformer-based model, as described in detail with reference to FIG. 2. Within the context example of identification of data flow issues, all available embedding models configured to capture the notion of dependency data can be selected, as candidate embedding models.

At 308, probes applicable to the source code fragment are determined, by the one or more processors. Not all available probes are relevant to a source code fragment. The probes can be determined based on one or more selection criteria, including identified measurable properties of the source code fragment and appropriate oracle tools. The identified measurable properties of the source code fragment include a syntax, semantics, structure, and performance. The oracle tools can include parsers, static analyzers, graph analysis tools, and profilers. For example, the selected probes can include any of a parser and a code dependency graph analyzer. A selection of probes can be performed according to the downstream tasks of the source code fragment.

At 310, performance metrics are generated for each combination of embedding model to probe pair, using the trained machine learning model and the reference classification models. The performance metrics can indicate how many probes each of the embedding model matches. The performance metrics can be compared to a threshold defining a minimal acceptable match between embedding model to probe pairs. The embedding model-probe pairs with performance metrics below the threshold can be removed from the selection, such that only embedding models with a number of matching probes exceeding the threshold are included in reports. The performance metrics can reveal the type of information captured by the embedding models.

At 312, a representation of each selected embedding model-probe pair is generated, from the reports, for visualization. The representation can include a graphical representation of each embedding model with the matching probes indicative of the performance metric. The representation can be a ranked representation hierarchically illustrating the selected embedding models with matching probes in a descending order according to the performance metric. The reported results can include an identifier of the source code fragments.

At 314, the embedding model is selected for processing the source code fragment. For example, one of the embedding models is selected, using the performance metrics to generate embeddings for the source code fragment, by converting the source code fragment into the numerical vectors.

At 316, a prompt for an analyzer is generated using the numerical vectors and a prompt template. Generating the prompt for the analyzer using numerical vectors can include transforming the vectors into a format that the analyzer can interpret and process to identify source code issues.

At 318, the prompt is processed by the analyzer (e.g., a machine learning model) to analyze and characterize the source code fragment to identify source code issues. The issues can be flagged as being relevant if one or more issue filtering criteria are met. In response to determining that the source code fragment includes critical issues (e.g., security-related issues), a correction plan can be generated.

The example process 300 for identification of code embeddings using a probing suite provides several significant advantages for machine learning training by efficiently identifying matching probe-embedding model pairs. By imposing additional constraints on the selection of probes and embedding models, the example process 300 increases the data processing efficiency. The described machine learning models learn to distinguish between matching and non-matching probe-embedding model pairs based on sophisticated characteristics of the actual source code fragment, leading to improved accuracy and consistency in the trained machine learning outputs. The example process 300 optimizes the identification of code embeddings using validated probes that are integrated in a source development workflow facilitating analysis for automatically reviewing updated source codes. The example process 300 advantageously includes a ranking process that selects the best probe-embedding model pairs, streamlining the identification of code embeddings using a probing suite and further enhancing the effectiveness of machine learning training. The described training results in a more robust and reliable model, capable of making more precise source code analysis using the output of the embedding models.

FIG. 4 is a block diagram of an example computing system 400 used to provide computational functionalities associated with described algorithms, methods, functions, processes, flows, and procedures, for example, as described with reference to FIG. 3, according to some implementations of the present disclosure. As shown in FIG. 4, the computing system 400 can include a processor 410, a memory 420, a storage device 430, and input/output devices 440. The processor 410, the memory 420, the storage device 430, and the input/output devices 440 can be interconnected using a system bus 450. The processor 410 is capable of processing instructions for execution within the computing system 400. Such executed instructions can implement one or more components of, for example, the code embedding identification system 108, described with reference to FIG. 1. In some implementations of the current subject matter, the processor 410 can be a single-threaded processor. Alternately, the processor 410 can be a multi-threaded processor. The processor 410 is capable of processing instructions stored in the memory 420 and/or on the storage device 430 to display graphical information for a user interface provided using the input/output device 440.

The memory 420 is a computer readable medium such as volatile or non-volatile that stores information within the computing system 400. The memory 420 can store data structures representing configuration object databases, for example. The storage device 430 is capable of providing persistent storage for the computing system 400. The storage device 430 can be a floppy disk device, a hard disk device, an optical disk device, or a tape device, or other suitable persistent storage means. The input/output device 440 provides input/output operations for the computing system 400. In some implementations of the current subject matter, the input/output device 440 includes a keyboard and/or pointing device. In various implementations, the input/output device 440 includes a display unit for displaying graphical user interfaces.

According to some implementations of the current subject matter, the input/output device 440 can provide input/output operations for a network device. For example, the input/output device 440 can include Ethernet ports or other networking ports to communicate with one or more wired and/or wireless networks (e.g., a LAN, a WAN, the Internet).

In some implementations of the current subject matter, the computing system 400 can be used to execute various interactive computer software applications that can be used for organization, analysis and/or storage of data in various (e.g., tabular) format (e.g., Microsoft Excel®, and/or any other type of software). Alternatively, the computing system 400 can be used to execute any type of software applications. These applications can be used to perform various functionalities, e.g., planning functionalities (e.g., generating, managing, editing of spreadsheet documents, word processing documents, and/or any other objects), computing functionalities, or communications functionalities. The applications can include various add-in functionalities (e.g., SAP Integrated Business Planning add-in for Microsoft Excel as part of the SAP Business Suite, as provided by SAP SE, Walldorf, Germany) or can be standalone computing products and/or functionalities. Upon activation within the applications, the functionalities can be used to generate the user interface provided using the input/output device 440. The user interface can be generated and presented to a user by the computing system 400 (e.g., on a computer screen monitor).

One or more aspects or features of the subject matter described herein can be realized in digital electronic circuitry, integrated circuitry, specially designed ASICs, FPGAS computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system can include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random-access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

The preceding figures and accompanying description illustrate example processes and computer implementable techniques. The environments and systems described above (or their software or other components) may contemplate using, implementing, or executing any suitable technique for performing these and other tasks. It will be understood that these processes are for illustration purposes only and that the described or similar techniques can be performed at any appropriate time, including concurrently, individually, in parallel, and/or in combination. In addition, many of the operations in these processes may take place simultaneously, concurrently, in parallel, and/or in different orders than as shown. Moreover, processes may have additional operations, fewer operations, and/or different operations, so long as the methods remain appropriate.

In other words, although the disclosure has been described in terms of certain implementations and generally associated methods, alterations and permutations of these implementations, and methods will be apparent to those skilled in the art. Accordingly, the above description of example implementations does not define or constrain the disclosure. Other changes, substitutions, and alterations are also possible without departing from the spirit and scope of the disclosure.

A number of implementations of the present disclosure have been described. Nevertheless, it will be understood that various modifications can be made without departing from the spirit and scope of the present disclosure. Accordingly, other implementations are within the scope of the following claims.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application.
Example 1. A computer-implemented method, comprising: receiving a source code fragment; determining embedding models corresponding to the source code fragment, each of the embedding models converting the source code fragment into numerical vectors that capture a semantic meaning and a functionality of the source code fragment; determining probes corresponding to properties of the source code fragment, each of the probes performing an analysis of the properties of the source code fragment; generating, using a machine learning model trained to process the embedding models and the probes, performance metrics indicative of encapsulations of the probes in the embedding models; and generating, a ranked representation of the embedding models using the performance metrics.
Example 2. The computer-implemented method of the preceding example, wherein the machine learning model comprises a support vector machine, a random forest, or a fully convolutional network.
Example 3. The computer-implemented method of any of the preceding examples, wherein the machine learning model is trained using labeled probes and labeled embedding models to determine whether one of the labeled probes is encapsulated in the labeled embedding models.
Example 4. The computer-implemented method of any of the preceding examples, comprising selecting one of the embedding models using the performance metrics to convert the source code fragment into the numerical vectors.
Example 5. The computer-implemented method of any of the preceding examples, wherein the embedding models comprise any of a graph-based model, a large language model, a token-based model, an abstract syntax tree model, and a transformer-based model.
Example 6. The computer-implemented method of any of the preceding examples, wherein the probes comprise any of a parser and a code dependency graph analyzer.
Example 7. The computer-implemented method of any of the preceding examples, wherein the properties of the source code fragment are aligned with downstream tasks targeted by the embedding models.
Example 8. A computer-implemented system comprising: a computing device; and a computer-readable storage device coupled to the computing device and having instructions stored thereon which, when executed by the computing device, cause the computing device to perform operations for selectively generating graphical representations with digital assistants in enterprise systems, the operations comprising: receiving a source code fragment; determining embedding models corresponding to the source code fragment, each of the embedding models converting the source code fragment into numerical vectors that capture a semantic meaning and a functionality of the source code fragment; determining probes corresponding to properties of the source code fragment, each of the probes performing an analysis of the properties of the source code fragment; generating, using a machine learning model trained to process the embedding models and the probes, performance metrics indicative of encapsulations of the probes in the embedding models; and generating, a ranked representation of the embedding models using the performance metrics.
Example 9. The computer-implemented system of any of the preceding examples, wherein the machine learning model comprises a support vector machine, a random forest, or a fully convolutional network.
Example 10. The computer-implemented system of the preceding example, wherein the machine learning model is trained using labeled probes and labeled embedding models to determine whether one of the labeled probes is encapsulated in the labeled embedding models.
Example 11. The computer-implemented system of any of the preceding examples, wherein the operations comprise: selecting one of the embedding models using the performance metrics to convert the source code fragment into the numerical vectors.
Example 12. The computer-implemented system of any of the preceding examples, wherein the embedding models comprise any of a graph-based model, a large language model, a token-based model, an abstract syntax tree model, and a transformer-based model.
Example 13. The computer-implemented system of any of the preceding examples, wherein the probes comprise any of a parser and a code dependency graph analyzer.
Example 14. The computer-implemented system of any of the preceding examples, wherein the properties of the source code fragment are aligned with downstream tasks targeted by the embedding models.
Example 15. A non-transitory computer-readable media encoded with a computer program, the computer program comprising instructions that when executed by one or more computers cause the one or more computers to perform operations comprising: receiving a source code fragment; determining embedding models corresponding to the source code fragment, each of the embedding models converting the source code fragment into numerical vectors that capture a semantic meaning and a functionality of the source code fragment; determining probes corresponding to properties of the source code fragment, each of the probes performing an analysis of the properties of the source code fragment; generating, using a machine learning model trained to process the embedding models and the probes, performance metrics indicative of encapsulations of the probes in the embedding models; and generating, a ranked representation of the embedding models using the performance metrics.
Example 16. The non-transitory computer-readable media of the preceding example, wherein the machine learning model comprises a support vector machine, a random forest, or a fully convolutional network.
Example 17. The non-transitory computer-readable media of any of the preceding examples, wherein the machine learning model is trained using labeled probes and labeled embedding models to determine whether one of the labeled probes is encapsulated in the labeled embedding models.
Example 18. The non-transitory computer-readable media of any of the preceding examples, wherein the operations comprise: selecting one of the embedding models using the performance metrics to convert the source code fragment into the numerical vectors, wherein the embedding models comprise any of a graph-based model, a large language model, a token-based model, an abstract syntax tree model, and a transformer-based model.
Example 19. The non-transitory computer-readable media of any of the preceding examples, wherein the probes comprise any of a parser and a code dependency graph analyzer.
Example 20. The non-transitory computer-readable media of any of the preceding examples, wherein the properties of the source code fragment are aligned with downstream tasks targeted by the embedding models.

What is claimed is:

1. A computer-implemented method, comprising:
receiving a source code fragment;
determining embedding models corresponding to the source code fragment, each of the embedding models converting the source code fragment into numerical vectors that capture a semantic meaning and a functionality of the source code fragment;
determining probes corresponding to properties of the source code fragment, each of the probes performing an analysis of the properties of the source code fragment;
generating, using a machine learning model trained to process the embedding models and the probes, performance metrics indicative of encapsulations of the probes in the embedding models; and
generating, a ranked representation of the embedding models using the performance metrics.

2. The computer-implemented method of claim 1, wherein the machine learning model comprises a support vector machine, a random forest, or a fully convolutional network.

3. The computer-implemented method of claim 1, wherein the machine learning model is trained using labeled probes and labeled embedding models to determine whether one of the labeled probes is encapsulated in the labeled embedding models.

4. The computer-implemented method of claim 1, comprising:
selecting one of the embedding models using the performance metrics to convert the source code fragment into the numerical vectors.

5. The computer-implemented method of claim 4, wherein the embedding models comprise any of a graph-based model, a large language model, a token-based model, an abstract syntax tree model, and a transformer-based model.

6. The computer-implemented method of claim 1, wherein the probes comprise any of a parser and a code dependency graph analyzer.

7. The computer-implemented method of claim 1, wherein the properties of the source code fragment are aligned with downstream tasks targeted by the embedding models.

8. A computer-implemented system comprising:
a computing device; and
a computer-readable storage device coupled to the computing device and having instructions stored thereon which, when executed by the computing device, cause the computing device to perform operations for selectively generating graphical representations with digital assistants in enterprise systems, the operations comprising:
receiving a source code fragment;
determining embedding models corresponding to the source code fragment, each of the embedding models converting the source code fragment into numerical vectors that capture a semantic meaning and a functionality of the source code fragment;
determining probes corresponding to properties of the source code fragment, each of the probes performing an analysis of the properties of the source code fragment;
generating, using a machine learning model trained to process the embedding models and the probes, performance metrics indicative of encapsulations of the probes in the embedding models; and
generating, a ranked representation of the embedding models using the performance metrics.

9. The computer-implemented system of claim 8, wherein the machine learning model comprises a support vector machine, a random forest, or a fully convolutional network.

10. The computer-implemented system of claim 8, wherein the machine learning model is trained using labeled probes and labeled embedding models to determine whether one of the labeled probes is encapsulated in the labeled embedding models.

11. The computer-implemented system of claim 8, wherein the operations comprise:
selecting one of the embedding models using the performance metrics to convert the source code fragment into the numerical vectors.

12. The computer-implemented system of claim 11, wherein the embedding models comprise any of a graph-based model, a large language model, a token-based model, an abstract syntax tree model, and a transformer-based model.

13. The computer-implemented system of claim 8, wherein the probes comprise any of a parser and a code dependency graph analyzer.

14. The computer-implemented system of claim 8, wherein the properties of the source code fragment are aligned with downstream tasks targeted by the embedding models.

15. A non-transitory computer-readable media encoded with a computer program, the computer program comprising instructions that when executed by one or more computers cause the one or more computers to perform operations comprising:
receiving a source code fragment;
determining embedding models corresponding to the source code fragment, each of the embedding models converting the source code fragment into numerical vectors that capture a semantic meaning and a functionality of the source code fragment;
determining probes corresponding to properties of the source code fragment, each of the probes performing an analysis of the properties of the source code fragment;
generating, using a machine learning model trained to process the embedding models and the probes, performance metrics indicative of encapsulations of the probes in the embedding models; and
generating, a ranked representation of the embedding models using the performance metrics.

16. The non-transitory computer-readable media of claim 15, wherein the machine learning model comprises a support vector machine, a random forest, or a fully convolutional network.

17. The non-transitory computer-readable media of claim 15, wherein the machine learning model is trained using labeled probes and labeled embedding models to determine whether one of the labeled probes is encapsulated in the labeled embedding models.

18. The non-transitory computer-readable media of claim 15, wherein the operations comprise:
selecting one of the embedding models using the performance metrics to convert the source code fragment into the numerical vectors, wherein the embedding models comprise any of a graph-based model, a large language model, a token-based model, an abstract syntax tree model, and a transformer-based model.

19. The non-transitory computer-readable media of claim 15, wherein the probes comprise any of a parser and a code dependency graph analyzer.

20. The non-transitory computer-readable media of claim 15, wherein the properties of the source code fragment are aligned with downstream tasks targeted by the embedding models.
